(19) United States
(12) Patent Application Publication
(10) Pub. No.: US 2020/0020492 A1
(43) Pub. Date: Jan. 16, 2020

(54) KEYBOARD DEVICE AND MANUFACTURING METHOD THEREOF

(71) Applicant: Primax Electronics Ltd., Taipei (TW)

(72) Inventors: Che-Wei Yang, Taipei (TW); Yi-Chen Wang, Taipei (TW); Chien-Hung Liu, Taipei (TW); Ming-Han Wu, Taipei (TW); Bo-An Chen, Taipei (TW); Yi-Wei Chen, Taipei (TW); Huang-Ming Chang, Taipei (TW); Chen-Hsuan Hsu, Taipei (TW)

(21) Appl. No.: 16/144,046

(22) Filed: Sep. 27, 2018

(30) Foreign Application Priority Data
Jul. 13, 2018 (TW) 107124307

(51) Int. Cl. H01H 13/7065; H01H 13/88; H01H 13/86

(52) U.S. Cl. CPC H01H 13/7065; H01H 13/86; H01H 13/88

(57) ABSTRACT

A keyboard device includes a membrane circuit board, a key frame, a position-limiting frame and a key structure. The key frame is located over the membrane circuit board. The position-limiting frame is located over the key frame. The key frame includes a first frame body and a first receiving hole. The first receiving hole runs through the first frame body along a vertical direction. The position-limiting frame includes a second frame body and a second receiving hole. The second receiving hole runs through the second frame body along the vertical direction. The second receiving hole is in communication with the first receiving hole. The key structure includes a keycap and a protrusion part. The keycap is movable within the first receiving hole and the second receiving hole. A portion of the protrusion part is located under the second frame body.

### FIELD OF THE INVENTION

The present invention relates to an input device, and more particularly to a keyboard device.

### BACKGROUND OF THE INVENTION

Generally, the widely-used peripheral input device of a computer system includes for example a mouse device, a keyboard device, a trackball device, or the like. Via the keyboard device, characters or symbols can be inputted into the computer system directly. As a consequence, most users and most manufacturers of the input devices pay much attention to the keyboard devices.

Hereinafter, the structure and the function of a conventional keyboard device will be illustrated with reference to FIGS. 1, 2, 3 and 4. FIG. 1 is a schematic top view illustrating the outward appearance of a conventional keyboard device. FIG. 2 is a schematic perspective view illustrating a portion of the keyboard device as shown in FIG. 1. FIG. 3 is a schematic exploded view illustrating a portion of the keyboard device as shown in FIG. 2. FIG. 4 is a schematic cross-sectional view illustrating a portion of the keyboard device as shown in FIG. 2. For succinctness, only a portion of the key frame, a single key structure and associated components are shown in FIGS. 2, 3 and 4.

The conventional keyboard device 1 comprises plural key structures 10, a base plate 11, a membrane circuit board 12 and a key frame 13. The membrane circuit board 12 comprises plural membrane switches 121 corresponding to the plural key structures 10. Each of the plural key structures 10 comprises a keycap 101, a scissors-type connecting element 102 and an elastic element 103. The scissors-type connecting element 102 is connected between the keycap 101 and the base plate 11. Moreover, the scissors-type connecting element 102 comprises a first frame 1021 and a second frame 1022. The second frame 1022 is pivotally coupled to the first frame 1021. Consequently, the first frame 1021 and the second frame 1022 can be swung relative to each other. The elastic element 103 is arranged between the keycap 101 and the base plate 11. Moreover, the elastic element 103 comprises a contacting part (not shown).

While the keycap 101 of any key structure 10 is depressed and moved downwardly relative to the base plate 11, the first frame 1021 and the second frame 1022 of the scissors-type connecting element 102 are switched from an open-scissors state to a stacked state. Moreover, as the keycap 101 is moved downwardly to compress the elastic element 103, the corresponding membrane switch 121 is pushed and triggered by the contacting part of the elastic element 103. Consequently, the keyboard device 1 generates a corresponding key signal. When the keycap 101 of the key structure 10 is no longer depressed, the keycap 101 is moved upwardly relative to the base plate 11 in response to an elastic force of the elastic element 103. Meanwhile, the first frame 1021 and the second frame 1022 are switched from the stacked state to the open-scissors state again, and the keycap 101 is returned to its original position.

The key frame 13 is located over the membrane circuit board 12. Moreover, the key frame 13 comprises a frame body 132 and plural receiving holes 131 corresponding to the plural key structures 10. The keycap 101 of the key structure 10 is movable within the corresponding receiving hole 131. However, since the keycap 101 of the conventional keyboard device 1 is fixed on the base plate 11 through the scissors-type connecting element 102 only, some drawbacks occurs. For example, if the clicking force acting on the keycap 101 is larger or the keycap 101 is picked by the user, the keycap 101 is readily detached from the keyboard device 1. In other words, the conventional keyboard device 1 needs to be further improved.

### SUMMARY OF THE INVENTION

An object of the present invention provides a keyboard device with a position-limiting frame. The position-limiting frame is used for limiting the position of a keycap of a key structure. Consequently, even if the clicking force acting on the keycap is larger or the keycap is picked by the user, the keycap is not readily detached from the keyboard device.

Another object of the present invention provides a method for manufacturing the above keyboard device.

In accordance with an aspect of the present invention, there is provided a keyboard device. The keyboard device includes a membrane circuit board, a key frame, a position-limiting frame and a key structure. The membrane circuit board includes a membrane switch. The key frame is located over the membrane circuit board, and includes a first frame body and a first receiving hole. The first receiving hole runs through the first frame body along a vertical direction. The position-limiting frame is located over the key frame, and includes a second frame body and a second receiving hole. The second receiving hole runs through the second frame body along the vertical direction. The second receiving hole is in communication with the first receiving hole. The second receiving hole is smaller than the first receiving hole. The key structure is aligned with the membrane switch, and includes a keycap and a protrusion part. While the keycap is depressed, the keycap is moved within the first receiving hole and the second receiving hole. A first end of the protrusion part is connected with a lateral edge of the keycap. A second end of the protrusion part is protruded from the lateral edge of the keycap to a position under the second frame body.

In accordance with another aspect of the present invention, there is provided a method for manufacturing the keyboard device of the present invention. In a step (P1), the key structure is placed on the base plate. The base plate is located under the membrane circuit board. In a step (P2), the key frame is placed on the membrane circuit board. When the key frame is disposed on the membrane circuit board, the first receiving hole is aligned with the keycap. In a step (P3), the position-limiting frame is placed on the key frame. When the position-limiting frame is disposed on the key frame, the second receiving hole is aligned with the keycap and the protrusion part is located under the second frame body.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic top view illustrating the outward appearance of a conventional keyboard device;

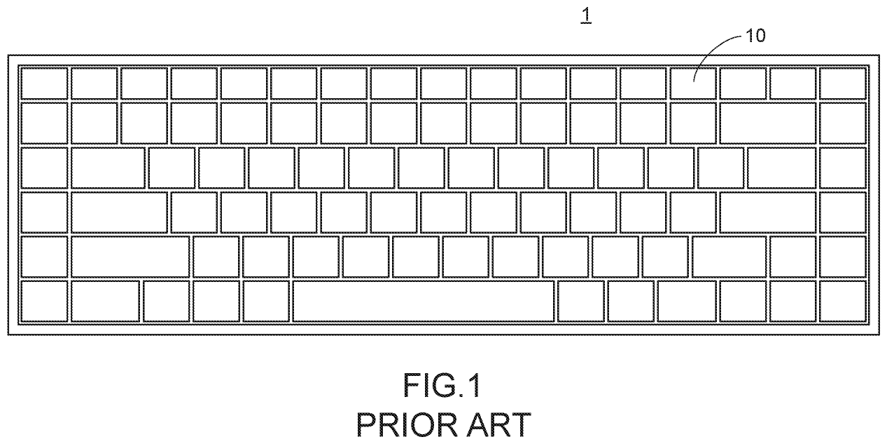

FIG. 2 is a schematic perspective view illustrating a portion of the keyboard device as shown in FIG. 1;

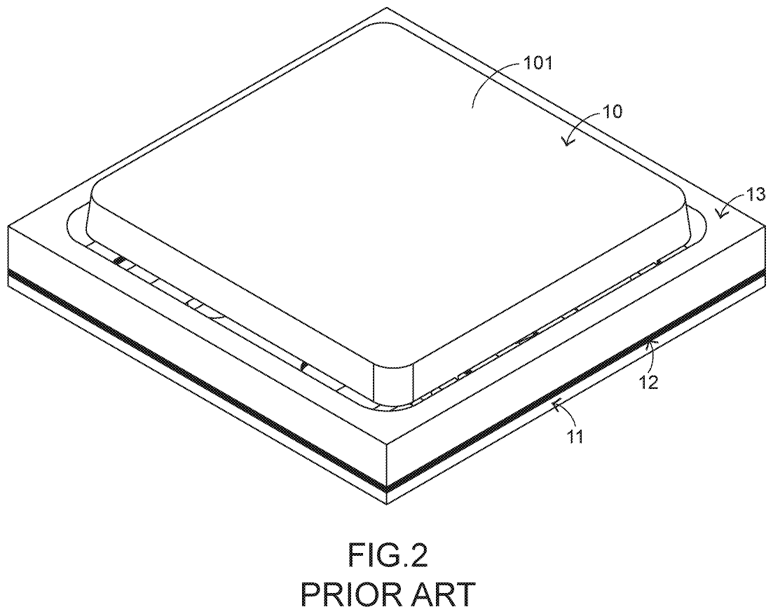

FIG. 3 is a schematic exploded view illustrating a portion of the keyboard device as shown in FIG. 2;

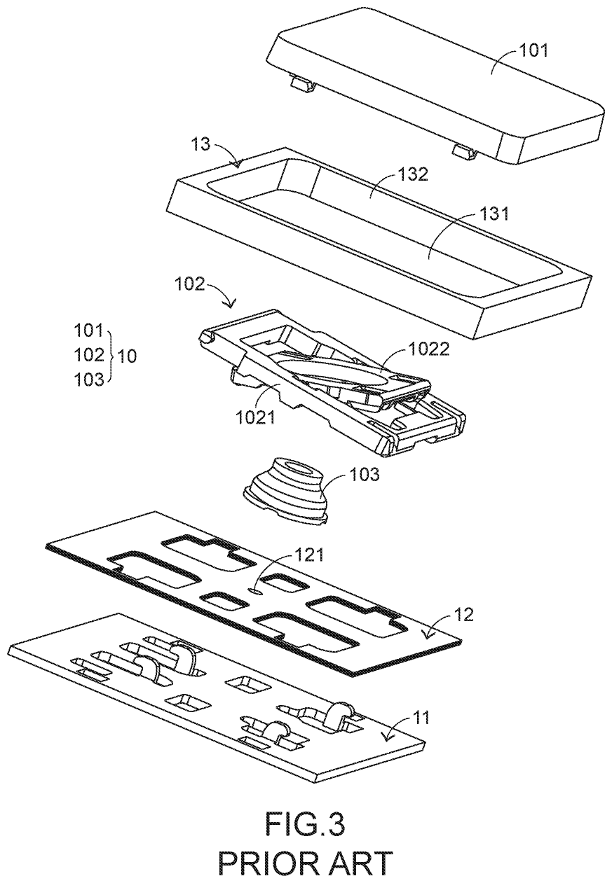

FIG. 4 is a schematic cross-sectional view illustrating a portion of the keyboard device as shown in FIG. 2;

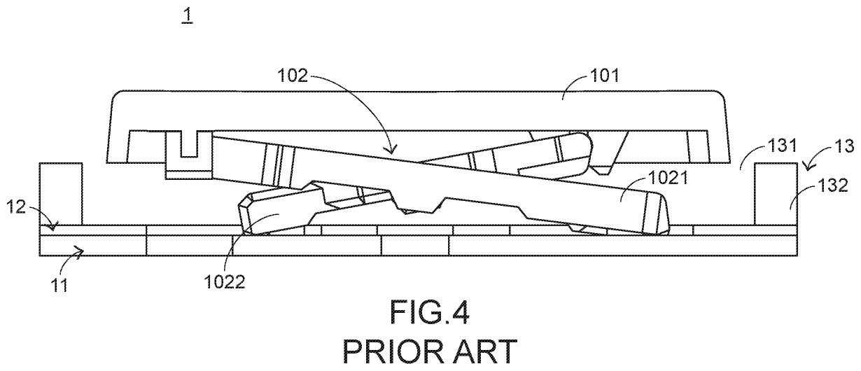

FIG. 5 is a schematic top view illustrating the outward appearance of a keyboard device according to a first embodiment of the present invention;

FIG. 6 is a schematic perspective view illustrating a portion of the keyboard device as shown in FIG. 5;

FIG. 7 is a schematic exploded view illustrating a portion of the keyboard device as shown in FIG. 6;

FIG. 8 is a schematic cross-sectional view illustrating a portion of the keyboard device as shown in FIG. 6;

FIG. 9 is a schematic exploded view illustrating the membrane circuit board of the keyboard device as shown in FIG. 5;

FIG. 10 is a schematic cross-sectional view illustrating a portion of a keyboard device according to a second embodiment of the present invention;

FIG. 11 is a schematic cross-sectional view illustrating a portion of a keyboard device according to a third embodiment of the present invention;

FIG. 12 is a schematic cross-sectional view illustrating a portion of a keyboard device according to a fourth embodiment of the present invention;

FIG. 13 is a flowchart illustrating a method for manufacturing a keyboard device according to an embodiment of the present invention;

FIG. 14A schematically illustrates the step P1 of the manufacturing method of FIG. 13;

FIG. 14B schematically illustrates the step P2 of the manufacturing method of FIG. 13; and

FIG. 14C schematically illustrates the step P3 of the manufacturing method of FIG. 13.

### DETAILED DESCRIPTION OF THE PREFERRED EMBODIMENT

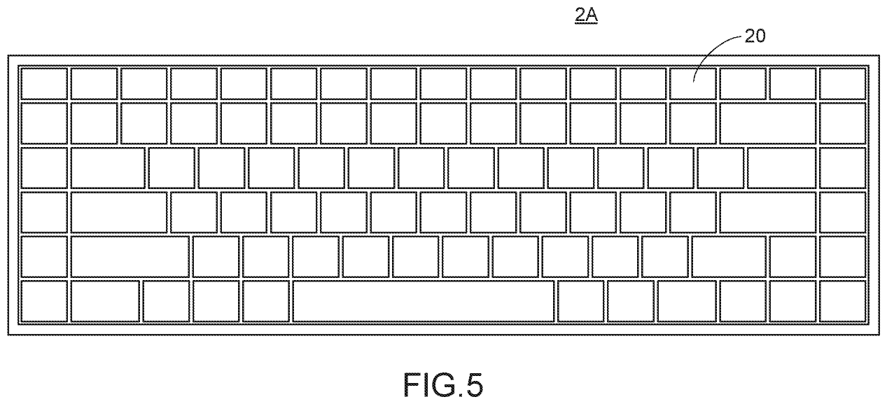

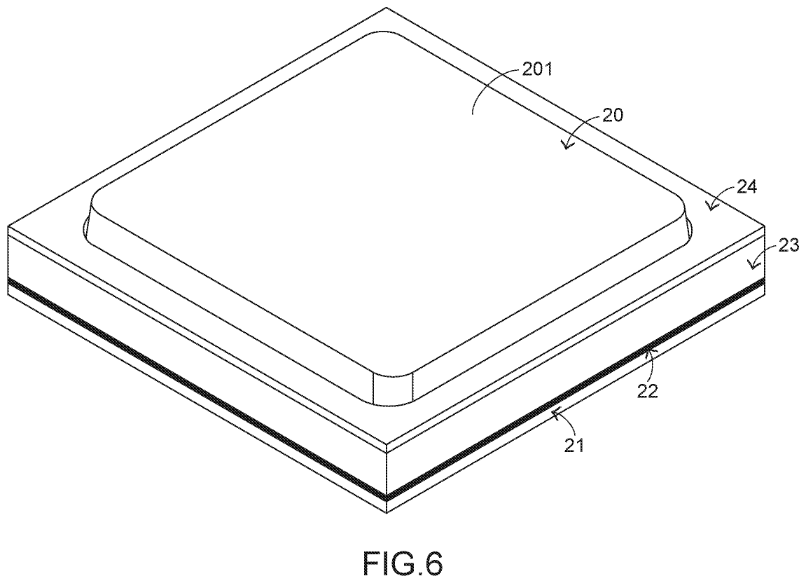

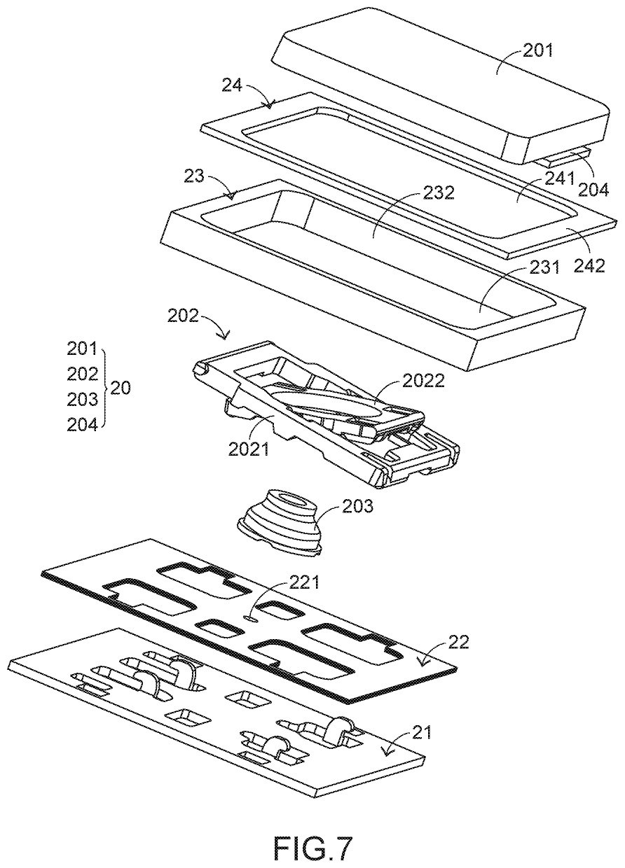

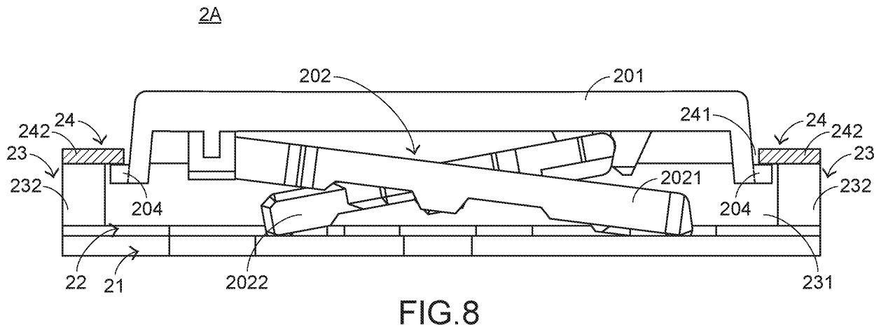

Please refer to FIGS. 5, 6, 7 and 8. FIG. 5 is a schematic top view illustrating the outward appearance of a keyboard device according to a first embodiment of the present invention. FIG. 6 is a schematic perspective view illustrating a portion of the keyboard device as shown in FIG. 5. FIG. 7 is a schematic exploded view illustrating a portion of the keyboard device as shown in FIG. 6. FIG. 8 is a schematic cross-sectional view illustrating a portion of the keyboard device as shown in FIG. 6. For succinctness, only a portion of a key frame, a portion of a position-limiting frame, a single key structure and associated components are shown in FIGS. 6, 7 and 8. In this embodiment, the keyboard device 2A comprises plural key structures 20, a base plate 21, a membrane circuit board 22, a key frame 23 and a position-limiting frame 24. These key structures 20 are classified into some types, e.g., ordinary keys, numeric keys and function keys. When one of the key structures 20 is depressed by the user's finger, the keyboard device 2A generates a corresponding key signal to a computer, and thus the computer executes a corresponding function. For example, when an ordinary key is depressed, a corresponding English letter or symbol is inputted into the computer. When a numeric key is depressed, a corresponding number is inputted into the computer. In addition, the function keys (F1˜F12) can be programmed to provide various quick access functions.

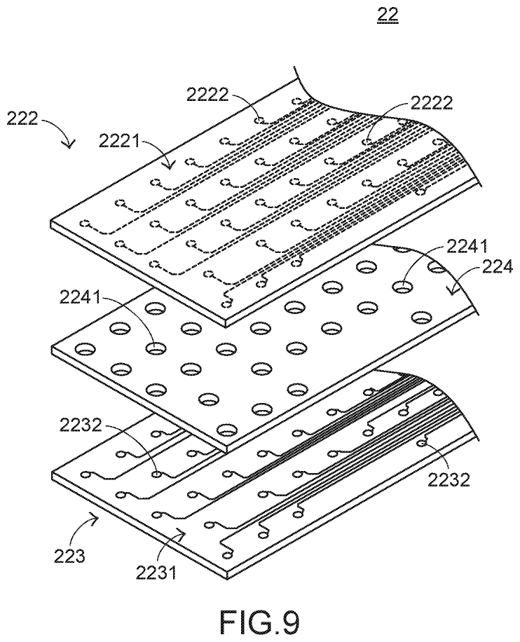

FIG. 9 is a schematic exploded view illustrating the membrane circuit board of the keyboard device as shown in FIG. 5. The membrane circuit board 22 comprises plural film layers, which are arranged in a stack form. In this embodiment, the plural film layers of the membrane circuit board 22 comprise an upper film layer 222 and a lower film layer 223. A first circuit pattern 2221 is formed on a bottom surface of the upper film layer 222. The first circuit pattern 2221 comprises plural upper contacts 2222 corresponding to the plural key structures 20. A second circuit pattern 2231 is formed on a top surface of the lower film layer 223. The second circuit pattern 2231 comprises plural lower contacts 2232 corresponding to the plural upper contacts 2222. Each of the upper contacts 2222 and the corresponding lower contact 2232 are separated from each other by a spacing distance. Moreover, each of the upper contacts 2222 and the corresponding lower contact 2232 are collectively defined as a membrane switch 221. Moreover, for maintaining the spacing distance between each upper contact 2222 and the corresponding lower contact 2232, the membrane circuit board 22 further comprises an intermediate film layer 224. The intermediate film layer 224 is arranged between the upper film layer 222 and the lower film layer 223. In addition, the intermediate film layer 224 comprises plural perforations 2241 corresponding to the plural upper contacts 2222 and the plural lower contacts 2232. Preferably but not exclusively, at least one of the upper film layer 222, the lower film layer 223 and the intermediate film layer 224 is made of polycarbonate (PC), polyethylene terephthalate (PET), polymethylmethacrylate (PMMA), polyurethane (PU) or polyimide (PI).

Each of the plural key structures 20 comprises a keycap 201, a connecting element 202 and an elastic element 203. The connecting element 202 is connected between the keycap 201 and the base plate 21. Through the connecting element 202, the keycap 201 is moved upwardly or downwardly relative to the base plate 21. The elastic element 203 is arranged between the keycap 201 and the base plate 21. Moreover, the elastic element 203 comprises a contacting part (not shown). In this embodiment, the connecting element 202 is a scissors-type connecting element. Moreover, the connecting element 202 comprises a first frame 2021 and a second frame 2022. The second frame 2022 is pivotally coupled to the first frame 2021. Consequently, the first frame 2021 and the second frame 2022 can be swung relative to each other.

While the keycap 201 of any key structure 20 is depressed and moved downwardly relative to the base plate 21, the first frame 2021 and the second frame 2022 of the scissors-type connecting element 202 are switched from an open-scissors state to a stacked state. Moreover, as the keycap 201 is moved downwardly to compress the elastic element 203, the corresponding upper contact 2222 is pushed and triggered by the contacting part of the elastic element 203. Consequently, the corresponding upper contact 2222 is contacted with the corresponding lower contact 2232 through the corresponding perforation 2241. In such way, the corresponding membrane switch 221 is electrically conducted, and the keyboard device 2A generates a corresponding key signal. When the keycap 201 of the key structure 20 is no longer depressed, the keycap 201 is moved upwardly relative to the base plate 21 in response to an elastic force of the elastic element 203. Meanwhile, the first frame 2021 and the second frame 2022 are switched from the stacked state to the open-scissors state again, and the keycap 201 is returned to its original position. The connecting relationships between the connecting element 202, the base plate 21 and the keycap 201 are presented herein for purpose of illustration and description only.

The key frame 23 is located over the membrane circuit board 22. Moreover, the key frame 23 comprises a first frame body 232 and plural first receiving holes 231 corresponding to the plural key structures 20. The plural first receiving holes 231 run through the first frame body 232 along a vertical direction. The position-limiting frame 24 is located over the key frame 23. The position-limiting frame 24 comprises a second frame body 242 and plural second receiving holes 241 corresponding to the plural key structures 20. The plural second receiving holes 241 run through the second frame body 242 along the vertical direction. The second receiving holes 241 are in communication with the corresponding first receiving holes 231. The keycap 201 of the key structure 20 is movable within the corresponding first receiving hole 231 and the corresponding second receiving hole 241. The size of the second receiving hole 241 is smaller than the size of the corresponding first receiving hole 231.

In this embodiment, each key structure 20 further comprises a protrusion part 204. A first end of the protrusion part 204 is connected with a lateral edge of the keycap 201. A second end of the protrusion part 204 is protruded from the lateral edge of the keycap 201 to a position under the second frame body 242. Consequently, the interference relationship between the protrusion part 204 and the second frame body 242 is established. When the keycap 201 is not depressed, the protrusion part 204 is contacted with a bottom surface of the second frame body 242. The position of the protrusion part 204 of the key structure 20 is limited by the second frame body 242 of the position-limiting frame 24. Consequently, when a larger clicking force exerted on the keycap 201 or keycap 201 is picked, the keycap 201 is not readily detached from the keyboard device 2A.

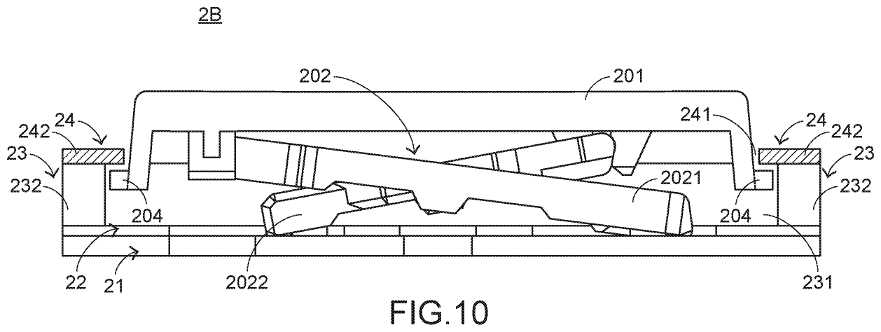

FIG. 10 is a schematic cross-sectional view illustrating a portion of a keyboard device according to a second embodiment of the present invention. For succinctness, only a portion of a key frame, a portion of a position-limiting frame, a single key structure and associated components are shown in FIG. 10. The structures and functions of the components of the keyboard device 2B which are identical to those of the first embodiment are not redundantly described herein. In comparison with the first embodiment, the following aspect is distinguished. When the keycap 201 is not depressed, the protrusion part 204 is separated from the bottom surface of the second frame body 242 by a gap. Consequently, while the keycap 201 is moved upwardly relative to the base plate 21 in response to the elastic force of the elastic element 203, the protrusion part 204 will not collide with the second frame body 242 to generate the unpleasant noise.

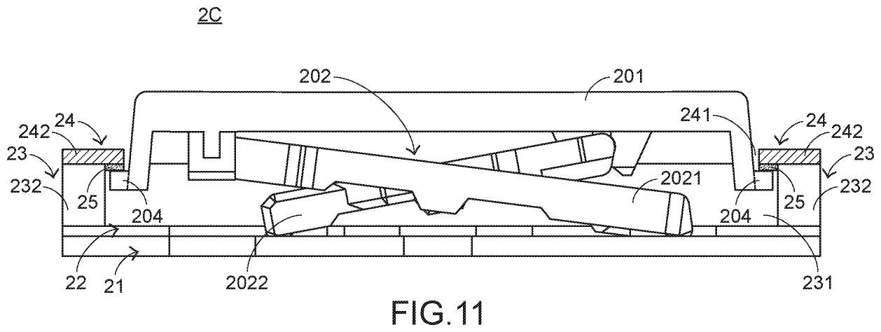

FIG. 11 is a schematic cross-sectional view illustrating a portion of a keyboard device according to a third embodiment of the present invention. For succinctness, only a portion of a key frame, a portion of a position-limiting frame, a single key structure and associated components are shown in FIG. 11. The structures and functions of the components of the keyboard device 2C which are identical to those of the first embodiment and the second are not redundantly described herein. In comparison with the first embodiment and the second embodiment, the following aspects are distinguished. The keyboard device 2C further comprises a buffering structure 25. The buffering structure 25 is made of an elastic element such as silicone rubber or pressure sensitive adhesive (PSA). The buffering structure 25 is arranged between the protrusion part 204 and the second frame body 242. Consequently, while the keycap 201 is moved upwardly relative to the base plate 21 in response to the elastic force of the elastic element 203, the collision between the protrusion part 204 and the second frame body 242 is alleviated.

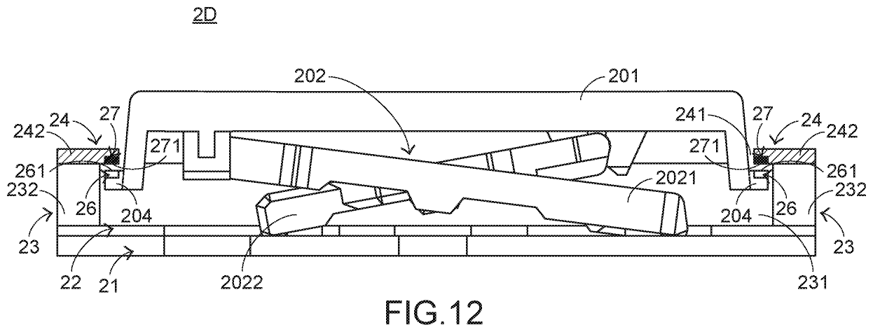

FIG. 12 is a schematic cross-sectional view illustrating a portion of a keyboard device according to a fourth embodiment of the present invention. For succinctness, only a portion of a key frame, a portion of a position-limiting frame, a single key structure and associated components are shown in FIG. 12. The structures and functions of the components of the keyboard device 2D which are identical to those of the first embodiment and the second are not redundantly described herein. In comparison with the first embodiment and the second embodiment, the following aspects are distinguished. In comparison with the first embodiment and the second embodiment, the following aspects are distinguished. The keyboard device 2D further comprises a first magnetic element 26 and a second magnetic element 27. The first magnetic element 26 is connected with the protrusion part 204. Moreover, at least a portion of the first magnetic element 26 is exposed outside the protrusion part 204, or the first magnetic element 26 is embedded within the protrusion part 204. The second magnetic element 27 is connected with the second frame body 242. Moreover, at least a portion of the second magnetic element 27 is exposed outside the second frame body 242, or the second magnetic element 27 is embedded within the second frame body 242. An end 261 of the first magnetic element 26 and an end 271 of the second magnetic element 27 are aligned with each other. That is, the end 261 of the first magnetic element 26 and the end 271 of the second magnetic element 27 are located adjacent to each other. The end 261 of the first magnetic element 26 and the end 271 of the second magnetic element 27 magnetically repel each other. Consequently, while the keycap 201 is moved upwardly relative to the base plate 21 in response to the elastic force of the elastic element 203, the collision between the protrusion part 204 and the second frame body 242 is avoided.

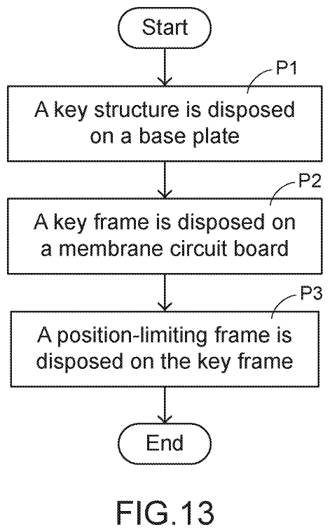

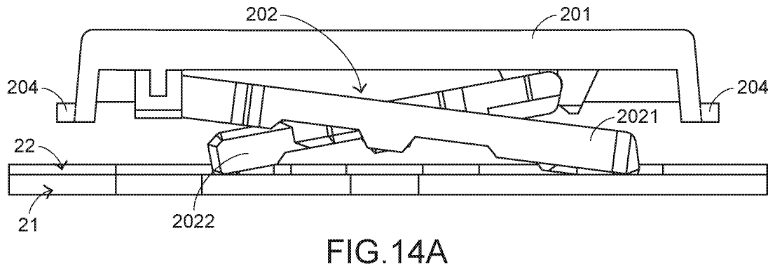

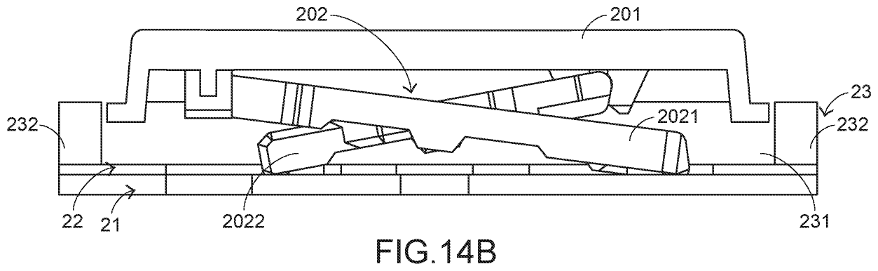

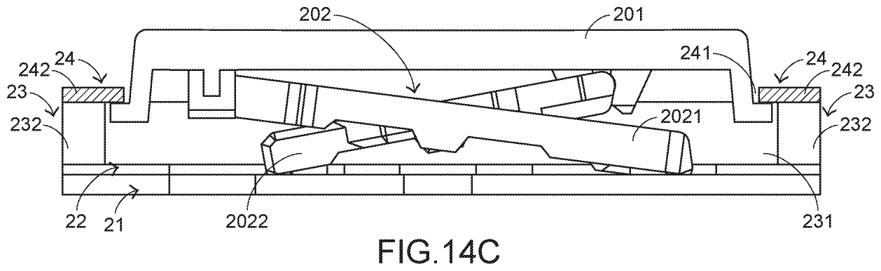

Hereinafter, a method for manufacturing a keyboard device will be described with reference to FIGS. 13, 14A, 14B and 14C. FIG. 13 is a flowchart illustrating a method for manufacturing a keyboard device according to an embodiment of the present invention. FIG. 14A schematically illustrates the step P1 of the manufacturing method of FIG. 13. FIG. 14B schematically illustrates the step P2 of the manufacturing method of FIG. 13. FIG. 14C schematically illustrates the step P3 of the manufacturing method of FIG. 13. For succinctness, only a portion of a key frame, a portion of a position-limiting frame, a single key structure and associated components are shown in FIGS. 14A, 14B and 14C.

The manufacturing method of the keyboard device includes the following steps. In a step P1, a key structure 20 is disposed on a base plate 21 (see FIG. 14A). In a step P2, a key frame 23 is disposed on a membrane circuit board 22. When the key frame 23 is disposed on the membrane circuit board 22, each first receiving hole 231 is aligned with the corresponding keycap 201 (see FIG. 14B). In a step P3, a position-limiting frame 24 is disposed on the key frame 23. When the position-limiting frame 24 is disposed on the key frame 23, each second receiving hole 241 is aligned with the corresponding keycap 201 and at least a portion of each protrusion part 204 is located under the second frame body 242 (see FIG. 14C).

Preferably but not exclusively, the key frame 23 is made of a first material and the position-limiting frame 24 is made of a second material. The first material and the second material are different materials. In an embodiment, the first material is a plastic material, and the second material is a metallic material (e.g., aluminum). Consequently, the structural strength of the overall keyboard device is increased, and the appearance texture of the keyboard device is enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A keyboard device, comprising:
a membrane circuit board comprising a membrane switch;
a key frame located over the membrane circuit board, and comprising a first frame body and a first receiving hole, wherein the first receiving hole runs through the first frame body along a vertical direction;
a position-limiting frame located over the key frame, and comprising a second frame body and a second receiving hole, wherein the second receiving hole runs through the second frame body along the vertical direction, the second receiving hole is in communication with the first receiving hole, and the second receiving hole is smaller than the first receiving hole; and
a key structure aligned with the membrane switch, and comprising a keycap and a protrusion part, wherein while the keycap is depressed, the keycap is moved within the first receiving hole and the second receiving hole, wherein a first end of the protrusion part is connected with a lateral edge of the keycap, and a second end of the protrusion part is protruded from the lateral edge of the keycap to a position under the second frame body.

2. The keyboard device according to claim 1, wherein the key frame is made of a first material, and the position-limiting frame is made of a second material.

3. The keyboard device according to claim 2, wherein the first material is a plastic material, and the second material is a metallic material.

4. The keyboard device according to claim 1, wherein the protrusion part is contacted with the second frame body.

5. The keyboard device according to claim 1, wherein when the keycap is not depressed, the protrusion part and the second frame body are separated from each other by a gap.

6. The keyboard device according to claim 5, wherein the keyboard device further comprises a buffering element, and the buffering element is arranged between the protrusion part and the second frame body.

7. The keyboard device according to claim 1, wherein the keyboard device further comprises a first magnetic element and a second magnetic element, wherein the first magnetic element is connected with the protrusion part or embedded within the protrusion part, and the second magnetic element is connected with the second frame body or embedded within the second frame body, wherein an end of the first magnetic element and an end of the second magnetic element are aligned with each other, and the end of the first magnetic element and the end of the second magnetic element magnetically repel each other.

8. The keyboard device according to claim 1, wherein the membrane circuit board comprises an upper film layer and a lower film layer, wherein a first circuit pattern is formed on the upper film layer, a second circuit pattern is formed on the lower film layer, the first circuit pattern comprises an upper contact, and the second circuit pattern comprises a lower contact, wherein the upper contact and the lower contact are separated from each by a spacing distance and collectively defined as the membrane switch.

9. The keyboard device according to claim 1, wherein the keyboard device further comprises a base plate, and the key structure further comprises a connecting element, wherein the connecting element is connected between the base plate and the keycap, and the keycap is movable upwardly or downwardly relative to the base plate through the connecting element.

10. The keyboard device according to claim 9, wherein the connecting element is a scissors-type connecting element comprising a first frame and a second frame, and the second frame is pivotally coupled to the first frame.

11. The keyboard device according to claim 1, wherein the keyboard device further comprises an elastic element, and the elastic element is arranged between the keycap and the circuit board and comprises a contacting part, wherein while the keycap is depressed, the elastic element is compressed and the membrane switch of the circuit board is pushed by the contacting part, wherein when the keycap is not depressed, the keycap is returned to an original position in response to an elastic force provided by the elastic element.

12. A method for manufacturing the keyboard device according to claim 1, the method comprising steps of:
(P1) placing the key structure on a base plate, wherein the base plate is located under the membrane circuit board;
(P2) placing the key frame on the membrane circuit board, wherein when the key frame is disposed on the membrane circuit board, the first receiving hole is aligned with the keycap; and
(P3) placing the position-limiting frame on the key frame, wherein when the position-limiting frame is disposed on the key frame, the second receiving hole is aligned with the keycap and the protrusion part is located under the second frame body.
